(19) United States
(12) Patent Application Publication
(10) Pub. No.: US 2016/0232466 A1
(43) Pub. Date: Aug. 11, 2016

(54) METHOD AND DEVICE FOR DETERMINING RISKS ASSOCIATED WITH CUSTOMER REQUIREMENTS IN AN ORGANIZATION

(71) Applicant: Wipro Limited, Bangalore (IN)

(72) Inventors: Ritesh Kumar Jain, Bangalore (IN); Sateesh Theetha, Bangalore (IN)

(21) Appl. No.: 14/666,636

(22) Filed: Mar. 24, 2015

(30) Foreign Application Priority Data
Feb. 9, 2015 (IN) 637/CHE/2015

(51) Int. Cl. G06Q 10/06

(52) U.S. Cl. CPC G06Q 10/0635

(57) ABSTRACT

A method and a device for determining risks associated with customer requirements in an organization includes retrieving information about the organization from one or more sources. One or more categories are determined based on the retrieved information and the one or more categories are context sensitive for the organization. A weightage of each of the one or more categories is determined. A requirement for modifying current system of the organization is received from the user. A risk score of the requirement is determined based on the one or more categories and the weightage of each of the one or more parameters.

This application claims the benefit of Indian Patent Application No. 637/CHE/2015 filed Feb. 9, 2015, which is hereby incorporated by reference in its entirety.

### FIELD

This technology is related, in general to risk assessment, and more particularly, but not exclusively to a method and a computing device for determining risks associated with customer requirements in an organization.

### BACKGROUND

Any customer oriented establishment tries to understand customer requirements so as to cater to the specific needs of the customer. This, in turn, brings value to both the customer as well as to the establishment. Hence, there is a conscious drive for any establishment to weave a process that would yield results satisfying their customers.

While the current Customer Relationship Management (CRM) systems are robust and have mature capabilities to handle ad hoc events and can be adaptive, there lies an inherent tradeoff in bringing a change that may have been requested by a customer. Few examples of trade off could be, the purported change when implemented, may lead to deterioration of the technical performance of the current system. Alternatively, the nature of the purported change could be such that it may violate establishment policies, rules and behavior that are fundamental to the establishment. There may be a possibility that the very nature of the purported change may be contrary to natural law, common sense or may violate the laws of the land, etc.

As of now, the customer requirements are not evaluated from these perspectives and hence may risk the success of the establishment. Few such evaluations may be done manually, thereby introducing too much subjectivity, inconsistency and inaccuracy into such evaluations.

If the customer centricity of a business established is not implemented with proper checks and balances, it may badly affect the interests of both the customer as well as the establishment.

### SUMMARY

Disclosed herein are a method and a computing device for determining risks associated with customer requirements in an organization. The method comprises analyzing the patterns associated with the customer centric requirements and calculating the risk in context of the industry of the customer.

In an aspect of the present disclosure, a method for determining risks associated with customer requirements in an organization is provided. The method comprises retrieving information about the organization from one or more sources, determining one or more categories based on the retrieved information, wherein the one or more categories are context sensitive for the organization, determining weightage of each of the one or more categories, receiving a requirement for modifying current system of the organization from the user, determining a risk score of the requirement based on the one or more categories and the weightage of each of the one or more parameters.

In an embodiment of the present disclosure, a risk assessment computing device for determining risks associated with customer requirements in an organization is provided. The risk assessment computing device comprises a processor and a memory communicatively coupled to the processor. The memory stores processor-executable instructions, which, on execution, causes the processor to retrieve information about the organization from one or more sources, determine one or more categories based on the retrieved information, wherein the one or more categories are context sensitive for the organization, determine weightage of each of the one or more categories, receive a requirement for modifying current system of the organization from the user, and determine a risk score of the requirement based on the one or more categories and the weightage of each of the one or more parameters.

In another aspect of the present disclosure, a non-transitory computer readable medium is disclosed. The non-transitory computer readable medium includes instructions stored thereon that when processed by a processor causes a risk assessment computing device to perform operations comprising retrieving information about the organization from one or more sources, determining one or more categories based on the retrieved information, wherein the one or more categories are context sensitive for the organization, determining weightage of each of the one or more categories, receiving a requirement for modifying current system of the organization from the user, determining a risk score of the requirement based on the one or more categories and the weightage of each of the one or more parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for determining risks associated with customer requirements in an organization in accordance with some embodiments of the present disclosure;

FIG. 2 illustrates a detailed block diagram of an exemplary risk assessment computing device in accordance with some embodiments of the present disclosure;

FIG. 3 illustrates an exemplary block diagram of an input module in accordance with some embodiments of the present disclosure; and

FIG. 4 shows a flowchart illustrating a method for determining risks associated with customer requirements in an organization in accordance with some embodiments of the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure are related to a method and a risk assessment computing device for determining risks associated with customer requirements in an organization. The risk assessment computing device performs risk assessment of potential change in customer focused application. The method of the present disclosure considers various aspects within an organization considering the customer at the center. The assessment helps to measure the potential impact of non-customer centric parameters and provide guidelines on when not to change even though there are customer requests.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

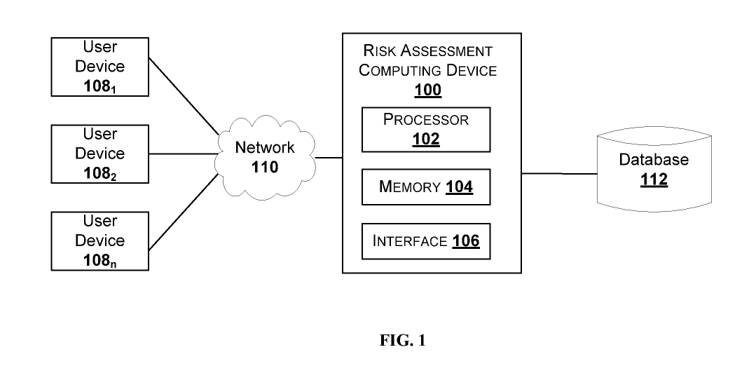

FIG. 1 illustrates an exemplary environment for determining risks associated with customer requirements in an organization in accordance with some embodiments of the present disclosure.

As shown in FIG. 1, then environment comprises a risk assessment computing device 100 for determining risks associated with customer requirements in an organization. The environment also comprises one or more user devices 108₁, 108₂, . . . 108ₙ (collectively referred to as user devices 108) and a database 112 connected to the risk assessment computing device 100. As shown in the FIG. 1, the user devices 108 are communicatively coupled to the risk assessment computing device 100 through a network 110 for receiving input data.

The user devices 108 comprise an application program that uses the services of the risk assessment computing device 100. The user devices 108 with the application program may be implemented in a variety of computing systems, such as a laptop computer, a desktop computer, a notebook, a workstation, a mainframe computer, a server, a network server, and the like. The user devices 108 may be used by various stakeholders or end users of the organization, such as administrators, project managers, executives and employees.

In an embodiment, the user devices 108 are used by associated users to receive input data regarding customer requirement and other information relating to risk assessment. The user devices 208 are installed with interface 106 for communicating with the risk assessment computing device 100 over the network 110. It will be understood by one skilled in the art that connections to the network 110 may be wired, wireless or any combination thereof. For example, the user devices 208 may be connected to the risk assessment computing device 100 through wireless local area network (WLAN) technologies (e.g., Wi-Fi, 3G, Long Term Evolution (LTE)) or through a physical network connection to a computer network router or switch (e.g., Ethernet).

In one implementation, the risk assessment computing device 100, as shown in FIG. 1, includes a central processing unit (“CPU” or “processor”) 102, a memory 104 and an interface 106. The processor 102 may comprise at least one data processor for executing program components and for executing user- or system-generated requests. A user may include a person, a person using a device such as those included in this invention, or such a device itself. The processor 102 is configured to fetch and execute computer-readable instructions stored in the memory 104. The processor 102 may include specialized processing units such as integrated system (bus) controllers, memory management control units, floating point units, graphics processing units, digital signal processing units, etc. The processor 102 may use operating system stored in the memory 104. The operating system includes, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

In one implementation, the memory 104 is communicatively coupled to the processor 102. The memory 104 stores processor-executable instructions to determine risks associated with customer requirements in an organization. In one example, the memory 104 may include, without limitation, RAM, ROM, etc. Additionally, in one implementation, the memory 104 is communicatively coupled to the processor 102 via a storage interface (not shown). The storage interface may connect to memory 104 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The risk assessment computing device 100 may include the input/output (I/O) interface 106 for communicating with the one or more user devices 108.

In an implementation, the risk assessment computing device 100 also acts as user device. Therefore, the input data are directly received at the risk assessment computing device 100 for determine risks associated with customer requirements in an organization.

The database 112 stores information relating to determination of risk associated with customer requirements in an organization.

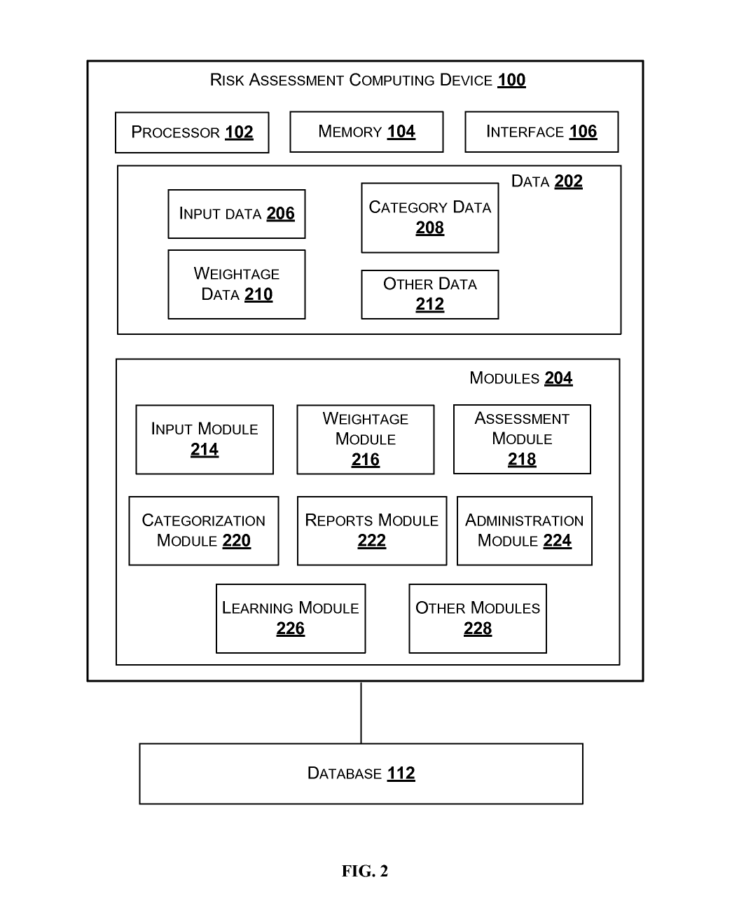

FIG. 2 shows detailed block diagram of risk assessment computing device 100 in accordance with some embodiments of the present invention.

In one implementation, the risk assessment computing device 100 may be implemented in a variety of computing systems, such as a laptop computer, a desktop computer, a notebook, a workstation, a mainframe computer, a server, a network server, and the like

In an embodiment, one or more data 202 may be stored within the memory 104. The one or more data 202 may include, for example, input data 206, category data 208, weightage data 210, other data 212. The other data 212 may be used to store data, including temporary data and temporary files, generated by modules 204 for performing the various functions of risk assessment computing device 100.

In an embodiment, the input data 206 comprises information about an organization. The input data 206 includes, but are not limited to information regarding the industry of the organization, size of the organization, customer of the organization, turnover of the organization. A person skilled in the art would understand that any other information relating to the organization may be stored as input data 206. In an exemplary embodiment, the input data may be stored in database 112. The user may update and/or modify the input data 206.

The category data 208 comprises information of one or more categories which are used for assessing risk. The one or more categories are automatically determined using the input data 206. In an embodiment, each one of the one more categories comprises one or more sub categories. As an example, the category data may comprise questions based on information of the organization. Based on answers to the questions, the risk associated with customer requirements is calculated. Few non limiting examples of categories are customer sentiment analysis, legal and compliance impact, organizational value analysis, impact of global variable and accidental events and benefit longevity analysis. The categories may change based on the type of organization and customers. Further, there can be sub categories for each of the one or more categories. For example, customer sentiment analysis category may have sub categories like limitation of change due to customer requirement, impact on social reputation of the organization, change in other key features due to the customer requirement etc.

The weightage data 210 comprises weightage assigned to each of the one or more categories. The weightage is assigned to each of the one or more parameters based on the input data 206. In an embodiment, the weightage is specified in percentage. The weightage data 210 is taken into consideration while assessing risk associated with customer requirements in the organization.

In an embodiment, the data 202 in the memory 104 is processed by the modules 204 of the processor 102. The modules 204 may be stored within the memory 104.

In one implementation, the modules may include, for example, an input module 214, a weightage module 216, an assessment module 218, a categorization module 220, a reports module 222, an administration module 224, a learning module 226 and other modules 228. The risk assessment computing device 100 may also comprise other modules 224 to perform various miscellaneous functionalities of the computing device 100. It will be appreciated that such aforementioned modules may be represented as a single module or a combination of different modules.

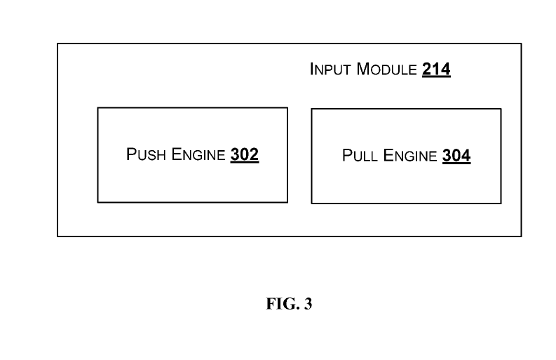

In an embodiment, the input module 214 receives input data 206 about the organization from one or more sources. The one or more sources may include, but are not limited to, Internet, social networks etc. The input module 214 comprises one or more sub modules, as illustrated in FIG. 3. The one or more sub modules of the input model 214 comprise a push engine 302 and a pull engine 304. Both the push engine 302 and the pull engine 304 are configured to extract information about the organization from one or more sources.

The push engine 302 retrieves feeds from various social networks. Further, the push engine 302 retrieves risk related information about the customer of the organization.

The pull engine 304 is configured to search the Internet and retrieve information about the customer, the industry and geography.

Referring back to FIG. 2, the weightage module 216 determines appropriate categories, questions in each of the categories and the respective weightage for the categories. The weightage module 216 determines the categories, questions and weightages based on the input data 206.

The assessment module 218 assesses the risk of the customer requirements of an organization. Accordingly, the assessment module 218 provides a risk score based on the assessment. The assessment module 218 determines the risk score based on the one or more categories and weightages assigned to each of the one or more categories. An exemplary assessment of risk of customer requirement is illustrated in Table 1 below. The below mentioned table illustrates only an exemplary method for risk assessment. The categories and weightages may change based on the type of organization.

TABLE 1

| | | | | | Sum of | Category | Weighted |
|---|---|---|---|---|---|---|---|
| Category | Sub Category | Weightage | Rating | Score | Score | Score | Score |
| Customer | 1. Is the context of | 20 | yes | 1 | 5 | 0.5 | 10.0 |
| Sentiment | the change very | | | | | | |
| Analysis | limited from the | | | | | | |
| | perspective of, | | | | | | |
| | a. Time | | | | | | |
| | b. Location | | | | | | |
| | c. Customers | | | | | | |
| | 2. Could there be | | yes | 1 | | | |
| | requirement | | | | | | |
| | specified by | | | | | | |
| | customer not fully | | | | | | |
| | met even after this | | | | | | |
| | change | | | | | | |
| | 3. Will making the | | no | 0 | | | |
| | desired change | | | | | | |
| | increase or | | | | | | |
| | decrease the | | | | | | |
| | number of steps for | | | | | | |
| | buying cycle | | | | | | |
| | (before buying and | | | | | | |
| | after buying) | | | | | | |
| | 4. Is the user | | yes | 1 | | | |
| | experience | | | | | | |
| | changing | | | | | | |
| | 5. Is the feature | | no | 0 | | | |
| | desired to be | | | | | | |
| | added/changed | | | | | | |
| | sacrifice any other | | | | | | |
| | key features | | | | | | |
| | 6. Is the impact on | | no | 0 | | | |
| | other | | | | | | |
| | features/products | | | | | | |
| | very high based on | | | | | | |
| | the change that is | | | | | | |
| | desired by specific | | | | | | |
| | customer | | | | | | |
| | 7. Does this change | | yes | 1 | | | |
| | warrant for | | | | | | |
| | feedback through | | | | | | |
| | sentimental | | | | | | |
| | analysis or any | | | | | | |
| | other method | | | | | | |
| | 8. Could this | | no | 0 | | | |
| | change impact the | | | | | | |
| | social reputation of | | | | | | |
| | the | | | | | | |
| | organization/brand | | | | | | |
| | 9. Is there a | | no | 0 | | | |
| | significant learning | | | | | | |
| | curve for end | | | | | | |
| | customers to utilize | | | | | | |
| | this changed | | | | | | |
| | feature | | | | | | |
| | 10. . . . | | yes | 1 | | | |
| Legal and | 1. | 30 | yes | 1 | 2 | 0.3 | 8.6 |
| Compliance | . . . | | no | 0 | | | |
| Impact | 7. | | yes | 1 | | | |
| | 8. | | no | 0 | | | |
| Organizational | 1. | 20 | Yes | 1 | 2 | 0.3 | 5.0 |
| Values | . . . | | Yes | 1 | | | |
| Analysis | 7. | | No | 0 | | | |
| | 8. | | No | 0 | | | |
| Impact of | 1. | 18 | Yes | 1 | 2 | 0.2 | 3.6 |
| Global | . . . | | No | 0 | | | |
| Variable | 9. | | Yes | 1 | | | |
| | 10. | | No | 0 | | | |
| Benefit | 1. | 12 | Yes | 1 | 2 | 0.4 | 4.8 |
| Longevity | . . . | | Yes | 1 | | | |
| | 4. | | No | 0 | | | |
| | 5. | | yes | 1 | | | |
| | Cumulative Score | | | 13 | 18 | | 32.0 |

In the above table, the first category is customer sentiment analysis which focuses on the organization need to understand the customer sentiments and the potential reason of the change. There can be instances where the need from customer is different from the request. This may portray wrong picture to organization on the required change.

The legal and compliance impact category has a list of questions for enterprises to evaluate which helps to determine whether the change that is desired is compliant from legal and any specific regulatory restrictions.

The organizational values analysis category addresses the enterprises need to ensure the changes are in line with organizations core values. This category looks at the impact of change and ensures that the integral value of the product stays intact.

The impact of global variable/accidental events category has a list of questions for enterprises to ensure the change is not limited to any specific events which are short lived and the occurrence of these events are very minimalistic in nature.

The benefit longevity analysis category has a list of questions for enterprises to ensure the change taken up will be for long term benefit and not a short term fix to satisfy specific customer segment or community. The score off this category ensures that holistic changes are taken up to meet long term vision.

In an embodiment, the overall risk assessment of a category is determined by:

X₀=X₀₀*W₀₀+X₀₁*W₀₁+ . . . +X₀ₙ*W₀ₙ (1)

### Where,

X₀, X₁, . . . , Xₙ are categories score
n is the number of sub categories with X₀ category
W₀, W₁, . . . , Wₙ are respective weightage of the categories X₀, X₁, . . . , Xₙ
X₀₀, X₀₁, X₀₂ are sub categories or risk score within category X₀
W₀₀, W₀₁, W₀₂ are weightage of each of these is depicted as . . . .

Further, overall risk score is determined by:

Overall risk score=X₀*W₀+X₁*W₁ . . . +Xₘ*Wₘ (2)

Where, m is the number of categories

The categorization module 220 categorizes the risk score of the customer requirement into one or more predefined categories. The risk score is evaluated to find the potential of the risk. The risk score is categorized and mapped to a dynamic predefined range.

As an example, the risk score is categorized into three ranges namely low, moderate and high risk. The size of these ranges will vary from industry to industry and based on goals of the organization. In an embodiment, the risk categorization into various ranges is done based on various parameters including, but not limited to, social hits, heuristic assessment and channel hits.

The factor for the range values is determined by:

D1=(B₁*C₁)+(B₂*C₂)+(B₃*C₃)+ . . . +(Bₙ*Cn) (1)

### Where,

B₁, B₂, B₃, . . . Bₙ are the parameters like social hits, heuristic assessment and channel hits
C₁, C₂, C₃, . . . Cₙ are weightage assigned to the respective parameters,

Now, the boundary of the standard risk categories can be considered as low (L₁), medium (M₁) and high (H₁). The categorization of risks into low, medium and high is determined by:

New L₁=L₁/D₁,

New M₁=M₁/D₁.

The risk categorization is performed based on below table, Table 2:

TABLE 2

| Risk Categorization | Risk Score |
|---|---|
| Low | Less than new L1 |
| Moderate | Between new L1 and new M1 |
| High | Greater than new M1 |

If the risk score is high, the organization needs to spend more time to evaluate the change. As an example, referring to Table 1, the risk categorization can be shown as below in Table 3:

TABLE 3

| Risk Categorization | Risk Score |
|---|---|
| Low | Less than 20 |
| Moderate | Between 20 and 40 |
| High | Greater than 40 |

As the weighted score according to Table 1 is 32, the risk is categorized as medium.

The reports module 222 provides analytical and comparative reports for the risk assessment of the customer requirements. The reports module 222 provides an insight to the organization about the perceived benefit of the change due to the customer requirements.

In an embodiment, the reports module 222 tracks and compares the various assessments done within an organization. The reports module 222 is typically used by management of the organization. They management may use the reports module 222 to generate reports on risk analysis assessment which are undertaken by various departments/divisions. Further, management may perform comparative analysis on the various changes and the risk assessment of those changes before or after the changes were done based on customer requests. In an embodiment, users with required access control may be able to view the report.

The administration module 224 manages the users of the risk assessment computing system 100. If the customer wants specific users to use the risk assessment computing device 100, then the administration module 224 provide respective access. In an embodiment, an administrator provides access and privileges to the various users based on the organization needs. The user can have one of plurality of roles including, but not limited to, administrator, customer relationship change owner and manager. The organization has a central implementation of the risk assessment computing device 100 with the customer relationship management team to evaluate the impact of changes requested by the customers. As an example, the administrator may perform the one or more activities using the administration module 224. The activities may include, but are not limited to, adding users, providing required privileges to users, modifying privileges for the users, deleting privileges for users and disabling users once they are not in the organization.

The learning module 226 is a self-learning module to enable users to learn usage of the risk assessment computing device 100. The learning module 226 also provides a self-help e-learning module. The module comprises context sensitive help on the various screens to explain how to use the risk assessment computing device 100. In an embodiment, the learning module 226 explains how to understand the assessment framework and reports associated with the framework.

The learning module 226 comprises collaborative features for user to ask questions to the administrator as well as post their learning and best practices that they have in their customer relationship management projects. This is done to ensure organizations goals are not lost and understanding when they should not consider changing.

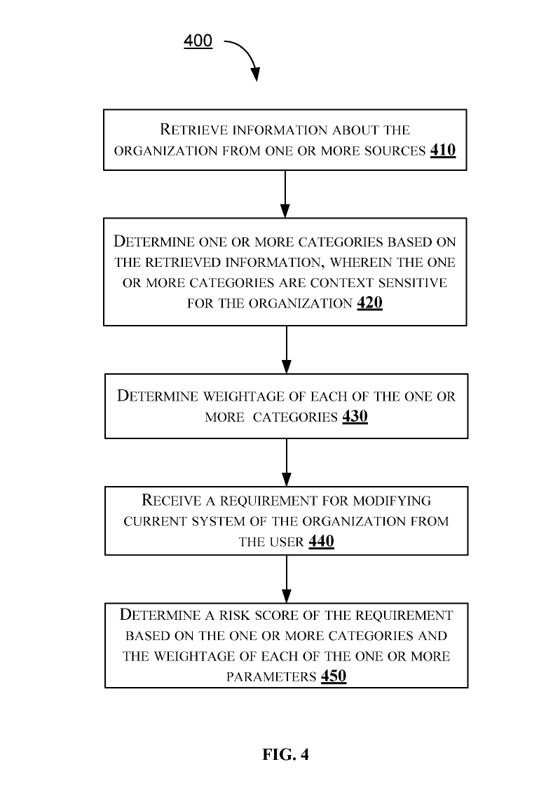

FIG. 4 shows a flowchart illustrating a method for determining risks associated with customer requirements in an organization in accordance with some embodiments of the present disclosure.

As illustrated in FIG. 4, the method 400 comprises one or more blocks for determining risks associated with customer requirements in an organization by the risk assessment computing device 100. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 410, retrieve, by the risk assessment computing device, information about the organization from one or more sources. In an embodiment, information includes, but is not limited to industry in which the organization in operating, geography of operation of the organization, legal status of the organization and financial stability of the organization. In an embodiment, the push engine 302 extract data from various feeds within and outside the organization using pre-built input channels. Further, a pull engine 304 comprises crawlers to capture context sensitive information about the organization from the Internet. This information is parsed and stored in the database 112. In an embodiment, the unstructured information is converted to structured information to for further analysis.

At block 420, determine, by the risk assessment computing device, one or more categories based on the retrieved information, wherein the one or more categories are context sensitive for the organization. At block 430, determine weightage of each of the one or more categories. In an embodiment, parameters which are context sensitive for that particular industry are determined. Also, weightages to each of the parameters is assigned. In an embodiment, the user can modify the parameters and weightage based on the organization needs. The revised parameters and weightages are also stored in the database 112. In an embodiment, the weightages are validated to detect any errors.

At block 440, receive, by the risk assessment computing device, a requirement for modifying current system of the organization from the user. The user requirement can be received from one or more sources like social network, feedback forms etc.

At block 450, determine, by the risk assessment computing device, a risk score of the requirement based on the one or more categories and the weightage of each of the one or more parameters. The risk score of the received customer requirement is determined based on the systems assessment of the various categories relevant to the organization and the weightages. These weightages could be the determined weightages, combined with user inputs or only the one provided by the user.

In an embodiment, the method further comprises categorizing the risk score based on the information about the organization, weightage of each information and a predefined risk threshold.

As an example of a context in which risk assessment of customer requirements is performed, consider the stake holder/organization as car manufacturer.

Assuming, the car manufacturer is looking to provide customized cars for customers. The car manufacturer may request for suggestion from within the organization as well as from the employees. For example, the customer suggests having flexibility to have different type and styles of steering wheels for high end version of cars. Such a request may be received through numerous sources. The sources may include, but are not limited to, customer feedbacks, dealers' network and social media. While the change will potentially provide a lot of positive attention by the customers, the car manufacturer assesses the risk associated with this customer requirement before implementing the change.

According to the method of the present disclosure, the risk assessment computing device 100 receives context aware information about the car manufacturing organization. The information may include, but is not limited to, type of industry, i.e. automotive industry, geography, i.e. selling cars in North America, car size i.e. sells mid-size cars, industry compliance based on country laws and analysis of type of customers i.e. middle class customers. All the received information is analyzed to determine parameters and weightages of the parameters that are relevant to the particular industry.

Then, the risk assessment computing device 100 computes weighted ranking of the various parameters based on the customer request. There are various aspects that determine the weightage of a change due to the customer request. For example, the risk assessment computing device 100 evaluates whether the change has been triggered by a social forum, whether belongs to certain geography, whether it relates to global event, etc. Like, for the category global event, more weight is assigned because of the reason of request. Additionally, if the country is going through a major legal change, then higher weightage is assigned to the impact of legal and compliance category.

Additionally, the user can modify weightage of one or more categories based on specific requirement of the organization. For example, the car manufacturer might decide to reduce the weightage of the benefit longevity category considering the model might again change after a year because of ongoing design work.

Further, the risk assessment computing device 100 receives the customer request, and the risk score for the change is determined and evaluated.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Advantages of the embodiment of the present disclosure are illustrated herein.

In an embodiment, the present disclosure provides content describing the aspects to look at which act as anti-pattern before making a change as requested by the customer. Some of the key aspects that are being addressed are need vs want analysis, impact of global variables, legal and compliance impact, organization value analysis, short term vs long term analysis.

In an embodiment, the present disclosure provides a solution for business to customer initiatives.

In an embodiment, the present disclosure considers various aspects within an organization considering the customer at the center to determine risk associated with customer requirement.

In an embodiment, the present disclosure helps to measure the potential impact of non-customer centric parameters and provides guidelines on when not to change even though there are customer requests.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference | |
|---|---|
| Number | Description |
| 100 | Risk Assessment Computing |
| | Device |
| 102 | Processor |
| 104 | Memory |
| 106 | Interface |
| 108₁, | User Devices |
| 108₂, . . . , 108ₙ | |
| 110 | Network |
| 112 | Database |
| 202 | Data |
| 204 | Modules |
| 206 | Input Data |
| 208 | Category Data |
| 210 | Weightage Data |
| 212 | Other Data |
| 214 | Input Module |
| 216 | Weightage Module |
| 218 | Assessment Module |
| 220 | Categorization Module |
| 222 | Reports Module |
| 224 | Administration Module |
| 226 | Learning Module |
| 228 | Other modules |
| 302 | Push Engine |
| 304 | Pull Engine |

What is claimed is:

1. A method for determining risks associated with customer requirements in an organization, the method comprising:
retrieving, by a risk assessment computing device, information about the organization from one or more sources;
determining, by the risk assessment computing device, one or more categories based on the retrieved information, wherein the one or more categories are context sensitive for the organization;
determining, by the risk assessment computing device, weightage of each of the one or more categories;
receiving, by the risk assessment computing device, a requirement for modifying current system of the organization from the user; and
determining, by the risk assessment computing device, a risk score of the requirement based on the one or more categories and the weightage of each of the one or more parameters.

2. The method as claimed in claim 1, wherein at least one of the determined one or more categories and weightages are modified by the user, said modified one or more categories and modified weightages are stored in a memory of the risk assessment computing device.

3. The method as claimed in claim 2, wherein determining the risk score of the requirement is based on the modified one or more categories and the modified weightages.

4. The method as claimed in claim 1, further comprising categorizing the risk score based on the information about the organization, weightage of each information and a predefined risk threshold.

5. The method as claimed in claim 1, wherein information about the organization is stored in a memory of the risk assessment computing device.

6. A risk assessment computing device for determining risks associated with customer requirements in an organization, comprising:
a processor; and
a memory communicatively coupled to the processor, wherein the memory stores processor-executable instructions, which, on execution, causes the processor to:
retrieve information about the organization from one or more sources;
determine one or more categories based on the retrieved information, wherein the one or more categories are context sensitive for the organization;
determine weightage of each of the one or more categories;
receive a requirement for modifying current system of the organization from the user; and
determine a risk score of the requirement based on the one or more categories and the weightage of each of the one or more parameters.

7. The risk assessment computing device as claimed in claim 6, wherein the determined weightages are modified by the user, said modified weightages are stored in a memory of the risk assessment computing device.

8. The risk assessment computing device as claimed in claim 7, wherein determining the risk score of the requirement is based on the modified one or more categories and the modified weightages.

9. The risk assessment computing device as claimed in claim 6, wherein the processor is further configured to categorize the risk score based on the information about the organization, weightage of each information and a predefined risk threshold.

10. The risk assessment computing device as claimed in claim 6, wherein information about the organization is stored in a memory of the risk assessment computing device.

11. A non-transitory computer readable medium including instructions stored thereon that when processed by at least one processor cause a risk assessment computing device to perform operations comprising:
retrieving information about the organization from one or more sources;
determining one or more categories based on the retrieved information, wherein the one or more categories are context sensitive for the organization;
determining weightage of each of the one or more categories;
receiving a requirement for modifying current system of the organization from the user; and
determining a risk score of the requirement based on the one or more categories and the weightage of each of the one or more parameters.

12. The medium as claimed in claim 11, wherein the instructions further cause the at least one processor to perform operations comprising receiving modified one or more categories and weightages by the user, said modified one or more categories and modified weightages are stored in a memory of the risk assessment computing device.

13. The medium as claimed in claim 11, wherein the instructions further cause the at least one processor to perform operations comprising categorizing the risk score based on the information about the organization, weightage of each information and a predefined risk threshold.
